(19) United States
(12) Patent Application Publication
(10) Pub. No.: US 2008/0296381 A1
(43) Pub. Date: Dec. 4, 2008

(54) Method and System for Filtering an Optical Lens

(76) Inventors: Ming YU, S. Setauket, NY (US); David Tsi Shi, Stony Brook, NY (US)

Correspondence Address: FAY KAPLUN & MARCIN, LLP, 150 BROADWAY, SUITE 702, NEW YORK, NY, 10038, US

(21) Appl. No.: 11/755,541

(22) Filed: May 30, 2007

(51) Int. Cl. G06K 7/10

(52) U.S. Cl. 235/462.01

(57) ABSTRACT

Described are a method and system for filtering an optical lens. The system includes an imager providing an image of a target based on light from the target; an optical lens having a light-filtering coating blocking ambient light, the optical lens focusing at least a portion of the light from the target onto the imager; and a processing device decoding the image of the target.

### FIELD OF INVENTION

The present invention generally relates to a scanning system and method for reading and/or analyzing optically encoded symbols in order to optimize performance for a device, such as a hand-held barcode scanner.

### BACKGROUND

Barcodes are machine-readable (i.e., computer readable) representations of information on a surface. Optical scanning devices such as laser-based barcode scanners and image-based scanners are used in a multitude of situations for both personal and business purposes. Typical barcodes include vertical bar symbols formatted as two-dimensional matrices. A variety of barcode readers and laser scanning devices have been developed to decode these bar symbols into a multiple-digit representation of information such as inventory checks, delivery tracking, product sales, etc.

Certain portable barcode scanners incorporate laser diodes that allow the user to scan the barcode symbols at various distances from the surface on which the barcode is imprinted. However, a disadvantage of a laser scanner is the expense in manufacturing the laser diodes. An alternative barcode scanner or imager may incorporate into a portable system the use of light emitting diodes (“LEDs”) as a light source and a photo-detector, such as a charge couple device (“CCD”). This class of barcode scanners or imagers is generally known as CCD scanners. CCD scanners can record symbols by storing an image of the symbol in a frame memory, which is then processed (e.g., scanned electronically) using software in order to convert the captured image into an output signal.

Standard barcode symbols are comprised of dark and light bars of varying widths. When light is projected onto these symbols, the light is mostly absorbed by the dark bars of the symbol and mostly scattered by the light bars of the symbol. Accordingly, the pattern of symbols may be read by photo-detectors within the scanner or imager devices. An alternative to the standard barcode symbols is fluorescent barcode symbols printed using fluorescent ink. The fluorescent ink of the symbol may be irradiated by light having a corresponding stimulation (or “excitement”) wavelength. Upon irradiating the fluorescent ink of the symbol, the ink emits light within a known band of wavelength readable to the photo-detector within the scanner or imager. Under normal lighting conditions, the fluorescent ink, itself, may be generally minimally visible, if not invisible, to the human eye. In addition, the light emitted from the fluorescent ink may also be minimally visible, if not invisible, to the human eye. Due to the fact that fluorescent barcodes are mostly invisible, the placement of a fluorescent barcode on a surface eliminates the need to obscure any underlying printed material on the surface. Furthermore, unlike the standard barcodes, the fluorescent barcode would not be difficult to read over a darken background or surface.

Fluorescent barcode reading systems may use filters to block ambient light while allow the light emitted from the fluorescent ink to pass. However, the filter on these systems is a separate component that is integrated into the barcode reader. Thus, the filter occupies more room and increases the cost of producing the systems.

### SUMMARY OF THE INVENTION

The present invention relates to a method and system for filtering an optical lens. The system includes an imager providing an image of a target based on light from the target; an optical lens having a light-filtering coating blocking ambient light, the optical lens focusing at least a portion of the light from the target onto the imager; and a processing device decoding the image of the target.

The method includes the following steps. Light is received from a target. Using a light-filtering coating on an optical lens, ambient light is blocked from entering an imager while allowing light having a wavelength within a predetermined range to enter the imager. An image of the target is created via the imager based on the light received by the imager. Finally, the image is decoded.

### BRIEF DESCRIPTION OF THE DRAWINGS

FIG. 1 shows an exemplary system for scanning and processing a fluorescent barcode symbol through the use of a computer-readable automatic identification symbol and a mobile unit (“MU”) such as hand-held barcode scanning mobile unit according to the present invention.

FIG. 2 represents the exemplary optical lens within the MU according to the exemplary embodiment of the present invention.

FIG. 3 represents an exemplary method for stimulating a fluorescent barcode and decoding the barcode according to the embodiment of the present invention.

FIG. 4 illustrates the operation of the exemplary optical lens of the imager in conjunction with the illuminating element and the fluorescent auto-id barcode symbol according to the exemplary embodiment of the present invention.

### DETAILED DESCRIPTION

The present invention may be further understood with reference to the following description of exemplary embodiments and the related appended drawings, wherein like elements are provided with the same reference numerals. The present invention generally relates to a scanning system and method for reading and/or analyzing optically encoded symbols in order to optimize performance for a device, such as a hand-held barcode scanner. Specifically, the present invention is related to a system and method for stimulating and reading fluorescent barcodes. The exemplary system and method described herein may employ the use of an optical lens including a fluorescent filter to allow for fluorescent light to pass though, while blocking “stray light,” such as ambient light, specular reflections, etc. According to further embodiments of the present invention, an exemplary fluorescent filter may also block out stimulating light emitted from the device, such as any stimulating light reflecting off a surface or barcode.

Various embodiments of the present invention will be described with reference to a portable barcode scanner, such as, for example, a hand-held mobile imager. However, those skilled in the art will understand that the present invention may be implemented with any electrical and/or mechanical scanning device that is capable of reading and processing symbols, such as barcode symbols.

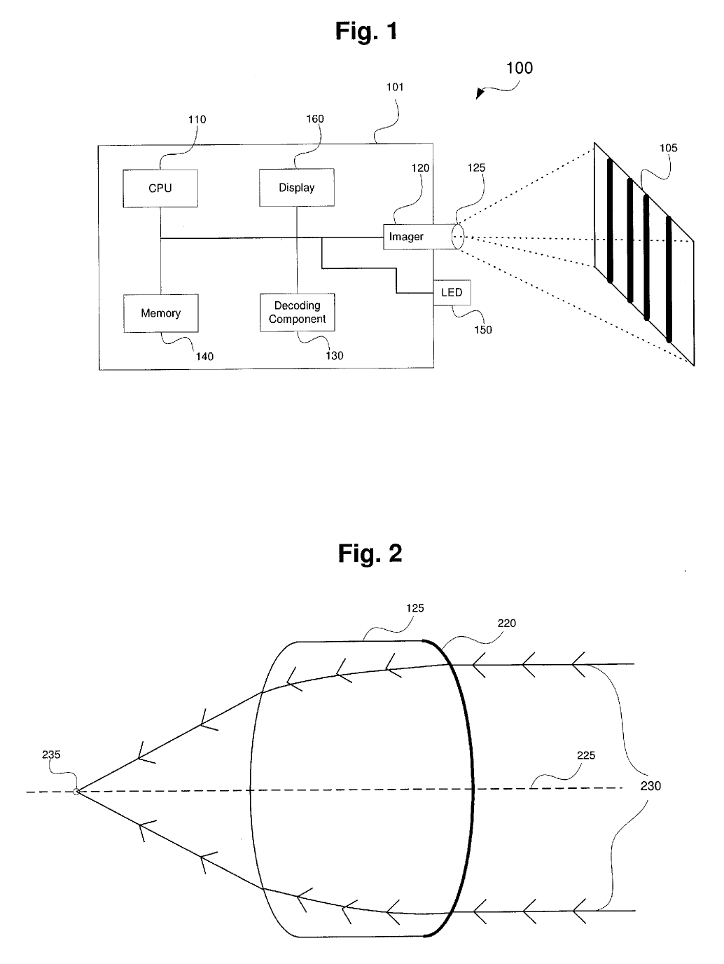

FIG. 1 shows an exemplary system 100 for scanning and processing a fluorescent barcode symbol through the use of a computer-readable auto-id symbol 105 and a device such as hand-held barcode scanning mobile unit (“MU”) 101. The exemplary MU 101 may be any data acquisition device having imaging capabilities, such as photo detectors, CCD sensors, active pixel sensors using complementary metal-oxide-semiconductor (“CMOS”) technology, etc. According to an exemplary embodiment, FIG. 1 shows a block diagram view of the handheld device 101 (e.g., the optical barcode scanner) according to the present invention. The MU 101 may include a “function module” or a central processing unit (“CPU”) 110, an imaging component (e.g., imager 120), an automatic identification (“auto-ID”) decoding component 130 (e.g., an optical barcode reader), a memory 140, an illumination element 150 (e.g., UV-emitting LED), and a display screen 160. While the MU 101 is illustrated in FIG. 1 as incorporating the illumination element 150 within the MU 101, an illumination element, according to an alternative embodiment, may be a separate component. For example, the illumination element 150 may be a “stand-alone” light source projection UV light onto items on a conveyer belt or similar work area.

The auto-id decoding component 130 may be communicatively coupled to the imager 120 of the MU 101 in order to process the images provided to the CPU 110 by the imager 120. The display screen 160 may provide a user of the MU 101 with a graphical representation of the status and functions of the MU 101. Furthermore, according to one embodiment of the present invention, the display screen 160 may be an input device, such as a touch screen, allowing for user input. In addition, the imager 120 may include an optical lens 125. While the optical lens 125 may be illustrated as a single lens, the imager 120 may employ a group of lenses to function collectively as a single optical lens. Therefore, the references through out this disclosure for the optical lens 125 is not limited to a single lens, but instead covers a plurality of lenses functioning as one lens. Accordingly, the imager 120 may include two lenses having four lens surfaces (i.e., two surfaces per lens). An anti-reflective coating may be applied to three of the four lens surfaces, and a fluorescent filter coating may be applied to the four surfaces. The selection for placing the filter within the group of lenses may be determined via a lens tracing operation performed on the group of lenses. The functions of the optical lens 125 will be described in greater detail below.

The CPU 110 may include one or more electrical and/or mechanical components for executing a function of the exemplary MU 101, such as barcode reading applications. Specifically, the CPU 110 may regulate the operation of the MU 101 by facilitating communications between the various components of the MU 101. For example, the CPU 110 may include a processor, such as a microprocessor, an embedded controller, an application-specific integrated circuit, a programmable logic array, etc. The CPU 110 may perform data processing, execute instructions and direct a flow of data between devices coupled to the CPU 110 (e.g., the imager 120, the auto-id decoding component 130, the memory 140, the display 160, etc.). As explained below, the CPU 110 may receive an input from the auto-id decoding component 130 and in response, may reference stored data within the memory 140 and display information to the user via the display 160.

The memory 140 may be any storage medium capable of being read from and/or written to by the CPU 110, or another processing device. The memory 140 may include any combination of volatile and/or nonvolatile memory (e.g., RAM, ROM, EPROM, Flash, etc.). The memory 140 may also include one or more storage disks such as a hard drive. According to one embodiment of the present invention, the memory 140 may be a temporary memory in which data may be temporarily stored until it is transferred to a permanent storage location (e.g., uploaded to a personal computer). In another embodiment, the memory 140 may be a permanent memory (e.g., an updateable database).

The computer-readable auto-id symbol 105 may be a barcode symbol printed onto a product or surface in fluorescent ink. Fluorescent ink may be described as containing a colored dye that may be activated (e.g., excited) through the use of an activating light source, such as a UV-light source provided by the illumination element 150 of the MU 101. Specifically, upon illuminating the fluorescent ink within the activating light source (e.g., UV-light source of illumination element 150), the fluorescent ink may be activated, thereby emitting an activated fluorescent light within a certain band of wavelengths. The imager 120 of the MU 101 may be capable of detecting this activated fluorescent light in order to read and process the pattern (i.e., barcodes) of the auto-id symbol 105 printed in the fluorescent link. According to an embodiment of the present invention, the exemplary fluorescent ink may be activated through an ultra-violet light source (e.g., the illumination element 150). However, it is important to note that additional embodiments within the scope of the present invention may use a variety of alternative inks and light sources, such as, for example, incandescent inks, phosphorescent inks, far-end and near-infrared activated inks and any corresponding stimulating light sources.

As described above, the illumination element 150 may allow the MU 101 to produce a stimulating light in order to activate the auto-id symbol 105. According to one embodiment of the present invention, the illumination element 150 may be a UV-emitting diode (“LED”) capable of activating fluorescent ink of the auto-id symbol 105. The imager 120 of the MU 101 may selectively activate the illumination element 150 when the imager 120 is attempting to capture an image of the auto-id symbol 105. The use of the illumination element 150 will be described in further detail below.

As discussed above, the imager 120 may include an optical lens 125 to allow light to enter the MU 101 for image processing. The optical lens 125 may be in the form of a shaped piece of glass or plastic. Specifically, the optical lens 125 may be described as a spherical lens, having surfaces with spherical curvatures, such as, biconvex lens, wherein both surfaces are convex. Those of skill in the art understand that a biconvex lens will allow a parallel beam of light traveling perpendicular to the lens will converge on a focal point after passing through the biconvex surfaces of the lens. While the exemplary embodiment of the present invention may utilize the imager 120 include the optical lens 125 having a biconvex shape, additional embodiments within the scope of the present invention may utilize an imaging component having an optical lens of any suitable shape. As described above, the optical lens 125 may be a group of several lenses. Accordingly, each lens within the group of lenses may be of any variety of shapes (e.g., biconvex, biconcave, opposing convex/concave, etc.).

The exemplary optical lens 125 may include one or more different optical coatings on the surfaces of the lens. The various optical coatings may include anti-reflection (“AR”) coatings and light-filtering coatings. The use of AR coatings on the optical lens 125 may allow for a reduction in interference reflections caused by the surface of the lens 125. Specifically, when a ray of light enters a medium, such as the optical lens 125, after traveling through the air, a portion of that light may be reflected from the surface of the medium, thereby detrimentally interfering with the amount of light that can travel through the optical lens 125. In order to decrease the amount of reflected light at the optical lens 125, a thin layer of AR coating may be applied to the optical lens 125. The AR coating may be composed of a material having a refractive index between those of the optical lens 125 and the air. Thus, the optical coatings may be described as a thin layer of material applied to the optical lens 125 that alters the manner in which the light is reflected from and/or transmitted through the optical lens 125. In addition to the AR coating, light filtering coatings may also be applied to the optical lens 125. The light-filtering coatings may designed for blocking (i.e., reflecting) light having specific wavelengths, or within a specific band of wavelengths. Accordingly, the light-filtering coating may be composed of a material that produces destructive interference to a specific band of wavelengths, thereby preventing certain wavelengths from traveling through the optical lens 125 at a given incident angle. The coatings may be a dielectric coating of any suitable thickness for accomplishing the intended filtering purpose and may be composed of multiple layers. The light-altering effects of the AR coatings and the light-filtering coatings will be described in greater detail below. As described above, the optical lens 125 may be a group of several lenses. Accordingly, each lens within the group of lenses may be applied with various coatings. For example, a single lens of the group may be applied with a light filtering coating while each of the other lenses may be applied with AR coatings.

According to an exemplary embodiment of the present invention, the imager 120 of the MU 101 may be in communication with the auto-id decoding component 130, such as the optical barcode reader, and may transmit captured image data to the decoding component 130. The decoding component 130 may then process the captured image data. The processed image data may be transmitted to the CPU 110 for further processing. Specifically, the CPU 110 may correlate the image data with any data stored within the memory 140 and/or separate storage component separate from the MU 101. While the decoding component 130, as illustrated in FIG. 1, appears as a separate component from the CPU 110, alternative embodiments of the present invention may incorporate the functions and processes of the decoding component 130 into the CPU 110, effectively combining the separate components into a single component.

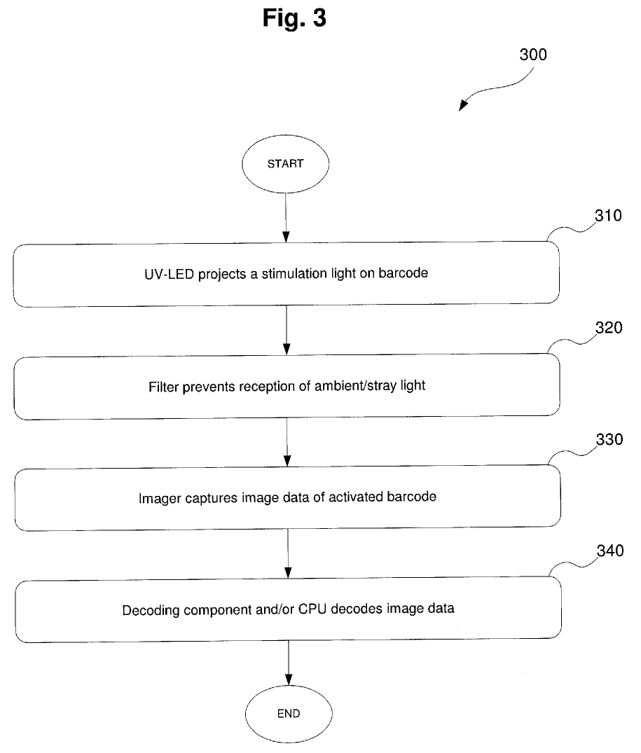

FIG. 2 represents an exemplary optical lens 125 within the MU 101 according to the exemplary embodiment of the present invention, wherein the optical lens 125 may be located within the imager 120 of the MU 101. According to one embodiment of the present invention, as illustrated in FIG. 2, the optical lens 125 may be a biconvex lens including a light-filtering coating, such as filter 220, on a surface of the optical lens 125. Thus, the biconvex optical lens 125 may have opposing convex sides and an axis 225 running perpendicular, or normal, to the opposing convex sides of the optical lens 125. While FIG. 2 illustrates the optical lens 125 only having the light-filtering coating 220, alternative embodiments of the optical lens 125 within the imager 120 may include additional coatings, such as one or more AR coatings in conjunction with the light-filtering coating 220. According to these alternative embodiments, the AR coating may be on the opposite surface of the optical lens 125 that the filter 220 is on.

For optimized performance of the filter 220, the filter 220 may be located on a lens surface with a small angle of ray incident as measured from the air-side. In order to find the corresponding angle of the lens 125, ray tracing may be performed to examine the path (relative to the axis 225) that a ray of light takes when interacting with the optical lens 125. Those of skill in the art understand that ray tracing may be described as a technique using optical geometry for modeling the manner in which light is affected by a surface.

According the exemplary embodiment of the present invention, ray tracing may be performed to determine the surface with the smallest incident angle (as measured from the air side) relative to surface normal, for the worst ray (i.e., the ray with the largest incident angle for that surface). The incident angle may be described as a measure of deviation from a direction normal to a surface. For example, in the lens 125 of FIG. 2, the first surface of the optical lens 125 may have a worst incident angle on its surface that is smaller than the worst incident angle of all other surfaces of the optical lens 125. Thus, the filter 220 may be located on the first surface of the optical lens 125. Accordingly, any coating (e.g., AR coating) on that surface of the optical lens 125 may be exchanged for a light-filtering coating (e.g., filter 220) that may provide proper blockage to stray and ambient light according to the embodiment of the present invention. Furthermore, the filter 220 may also be configured to block the light emitted from the illumination device 150. The light emitted from the illumination device 150 (e.g., the stimulating UV light) may be considered as “noise,” thereby interfering with the imaging ability of the imager 120. Specifically, the filter 220 may block stray light as well as any UV light reflected from the auto-id symbol 150 and the surrounding surfaces. Alternatively, the filer 220 may allow the reflected stimulating light to pass through to the imager 120. For example, if the auto-id symbol 150 is not composed of fluorescent ink, then the reflected stimulating light from the auto-id symbol 150 may not be considered as “noise.” Thus, the filter 220 may continue to block any stray and ambient light while permitting the stimulating light reflected from the auto-id 150 to pass through.

As described above, the exemplary filter 220 may be a fluorescent filter, capable of blocking stray light within the optical lens 125 while allowing fluorescent light to pass through the optical lens 125. Based on the biconvex shape of the optical lens 125, a beam of light 230 traveling parallel to an axis 225 of the lens 125 (in the direction indicated by the arrows in FIG. 2), may pass through the lens 125 and converge to a focal point 235 on the axis 225, behind the optical lens 125. The placement of the filer 220 on the least steep surface at the first surface of the optical lens 125 allows for the most effective filtering of the beam of light 230 directed toward to the imager 120 (i.e., normal to the optical lens 125).

FIG. 3 represents an exemplary method 300 for stimulating a fluorescent barcode and decoding the barcode according to the embodiment of the present invention. The exemplary method 300 will be described with reference to the exemplary system 100 of FIG. 1. As described above, the exemplary MU 101 may be a data acquisition device such as an optical barcode scanner for reading an auto-id barcode symbol 105 printed in fluorescent ink. Specifically, the MU 101 may include an imager 120 having an optical lens 125 with a fluorescent filter 220 for minimizing the amount of ambient light received by the imager 120. The MU 101 may further include an illumination element 150 for stimulating the fluorescent ink of the auto-id barcode symbol 105.

In step 310, the MU 101 may initiate a data acquisition process by projecting a stimulation light from the illumination element 150 towards the auto-id barcode symbol 105. According to the exemplary embodiment of the present invention, the illumination element 150 may be a UV-emitting LED, emitting electromagnetic energy, or radiation, within a wavelength range of 320-400 nanometers (i.e., long-wave UV radiation, or UV-A light).

In step 320, the MU 101 may prevent the reception of (e.g., block or filter out) ambient and/or stray light from the surrounding environment. While the step 320 is illustrated in FIG. 3 as following the step 310, it is important to note that step 320 may be performed on a continuous basis throughout the operation the MU 101. Accordingly, the illustration of the step 320 as a component within method 300 is not indented to limit the blocking of ambient or stray to any particular time frame within method 300.

As described above, the ambient light may be blocked out through the use of the filter 220 on the optical lens 125 of the imager 120. The ambient light and light from corresponding specular reflections may interfere with the ability of the imager 120 to make an accurate reading of the barcode symbol 105. Thus, the filter 220 may be designed to only allow light within a certain wavelength range to pass through. Specifically, the filter 220 may only allow light having a wavelength equivalent, or approximate, to that of the activated fluorescent light emitted from the barcode symbol 105, while blocking out light of any other wavelength (e.g., ambient light, stray light, specular reflections, etc.). According to the exemplary embodiment of the present invention, the filter 220 may be a coating applied directly to a surface of the optical lens 125.

In step 330, the imager 120 of the MU 101 may receive an activated fluorescent light emitted from the barcode symbol 105 in order to capture image data. As described above, the barcode symbol 105 may be printed in fluorescent ink. In other words, the barcode symbol 105 may contain a substance, such as a phosphor, that emits the activated fluorescent light in response to the UV radiation of the illumination element 150. Specifically, when the substance (e.g., the phosphor) is exposed to UV radiation, it may convert this electromagnetic energy received from the illumination element 150 into visible light, readable by the imager 120. Thus, the fluorescent ink of the barcode symbol 105 may initially be invisible to the human eye or to the imager 120. However, upon absorbing the UV radiation emitted from the illumination element 150, the barcode symbol 105 may then become visible (i.e., readable to the imager 120). The captured image data may be transmitted to one of the decoding component 130 and the CPU 110 for processing.

In step 340, the decoding component 130, or simply the CPU 110, of the MU 101 may decode the received image data of the barcode symbol 105. Specifically, the captured image data may be decoded into a multiple-digit representation or code represented by the barcode symbol 105. The image data may be decoded in accordance with an algorithm contained in a software program of the decoding component 130 or the CPU 110. Thus, the decoded image data may be correlated with any data stored within the memory 140 of the MU 101.

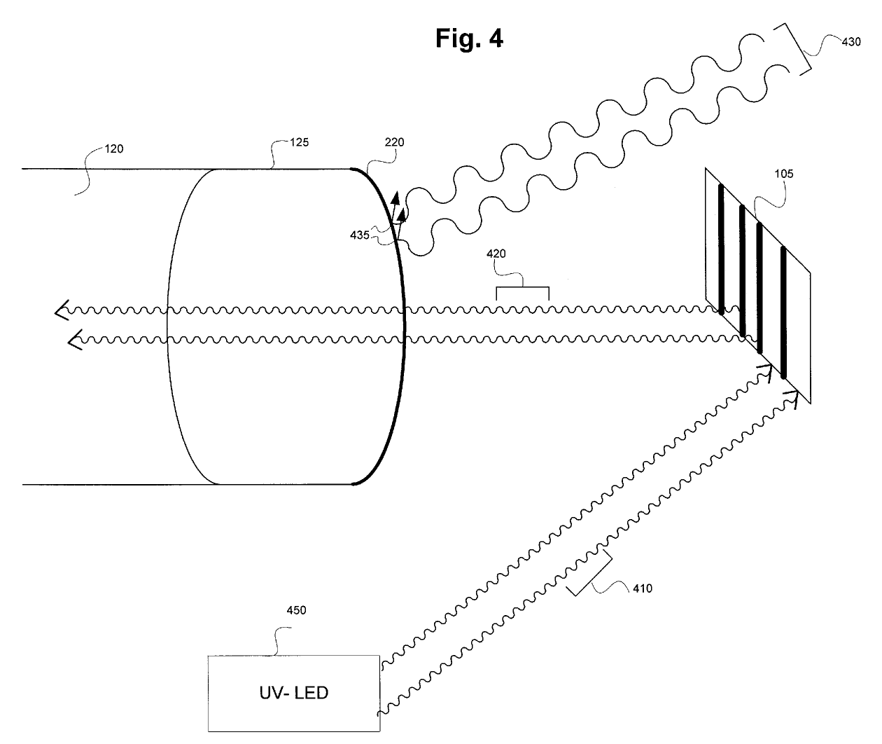

FIG. 4 illustrates the operation of the exemplary optical lens 125 of the imager 120 in conjunction with a UV-LED 450 and the fluorescent auto-id barcode symbol 105 according to the exemplary embodiment of the present invention.

The UV-LED 450 may emit UV radiation 410 for stimulating the fluorescent barcode symbol 105. As illustrated in FIG. 4, the UV radiation may have a relatively short wavelength (i.e., within a wavelength range of 320-400 nm). The fluorescent barcode may absorb the energy of the UV radiation 410, thereby activating the phosphors within the fluorescent ink. The activated phosphors may then transmit a corresponding activated fluorescent light 420 visible by the imager 120. Similar to the UV radiation 410 from the UV-LED 450, the activated fluorescent light 420 may also have a relatively short wavelength. The imager 120 includes the optical lens 125 and the filter 220 described in the above embodiments. In addition to the activated fluorescent light 420 from the barcode symbol 105, ambient light 430 may also be radiating toward the imager 120. As illustrated in FIG. 4, the ambient light 430 may have a relatively longer wavelength in relation to the UV radiation 410 (i.e., a wavelength greater than 400 nm).

As described above, the ambient light 430 may interfere with the ability of imager 120 to create an accurate image data of the barcode symbol 105. Thus, the optical lens 125 of the imager 120 may include a light-filtering coating, filter 220, applied directly to a surface of the optical lens 125. The filter 220 may be capable of blocking out, or reflecting, the ambient light 430 while allowing the activated fluorescent light 420 to pass through. For example, the filter 220 may allow light having relatively shorter wavelengths to pass while block light having longer wavelengths. As illustrated in FIG. 4, the filter 220 of the optical lens 125 may reflect the ambient light 430 at reflection points 435. In addition, the filter 220 allows the activated fluorescent light 420 from the barcode symbol 105 to pass through the imager 120.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A system, comprising:
an imager providing an image of a target based on light from the target;
an optical lens having a light-filtering coating blocking ambient light, the optical lens focusing at least a portion of the light from the target onto the imager; and
a processing device decoding the image of the target.

2. The system according to claim 1, further comprising:
an illumination element transmitting light to the target, the target including light-activated ink activated by the illumination element.

3. The system according to claim 1, wherein the illumination element is an ultra-violet (“UV”) light emitting diode (“LED”).

4. The system according to claim 1, wherein the target is a barcode symbol printed using a fluorescent ink, the target emitting a fluorescent light upon being activated, the fluorescent light having a wavelength within a predetermined range.

5. The system according to claim 1, wherein the light-filtering coating is located on a surface of the optical lens producing the smallest incident angle relative to surface normal for a worst ray.

6. The system according to claim 1, wherein the light-filtering coating is located on a surface of the optical lens.

7. The system according to claim 1, wherein the system is operable on an image-based barcode scanner.

8. The system according to claim 4, wherein the light-filtering coating allows the fluorescent light emitted from the target within the predetermined range to pass through to the imager while blocking light having a wavelength outside of the predetermined range.

9. The system according to claim 1, wherein an anti-reflective coating is applied to a surface of the optical lens.

10. A method, comprising:
receiving light from a target;
blocking, by a light-filtering coating on an optical lens, ambient light from entering an imager while allowing light having a wavelength within a predetermined range to enter the imager;
creating an image of the target via the imager based on the light received by the imager; and
decoding the image.

11. The method according to claim 10, further comprising:
projecting activating light onto the target, the target including light-activated ink activated by the illumination element.

12. The method according to claim 11, wherein the activating light is projected by an ultra-violet (“UV”) light emitting diode (“LED”).

13. The method according to claim 10, wherein the light-filtering coating is located on a surface of the optical lens.

14. The method according to claim 11, wherein the target is a barcode symbol printed in fluorescent ink, and the light received from the target is a fluorescent light.

15. The method according to claim 10, wherein the target is a barcode symbol printed in fluorescent ink, and the light received from the target is a fluorescent light.

16. The method according to claim 15, wherein the fluorescent light is within the predetermined range, the light-filtering coating allows the fluorescent light received from the target within the predetermined range to pass through to the imager while blocking light having a wavelength outside of the predetermined range.

17. The method according to claim 10, wherein the method is performed by an image-based barcode scanner.

18. The method according to claim 10, wherein an anti-reflective coating is applied to a surface of the optical lens.

19. An optical lens, comprising:
a body having a plurality of surface; and
a light-filtering coating applied to a surface of the surface producing a smallest incident angle relative to a surface normal for a worst ray.

20. The optical lens according to claim 19, wherein the light filtering coating blocks ambient light from passing out of the body while allowing light having a wavelength within a predetermined range to pass through the body.

21. The optical lens according to claim 19, further comprising:
an anti-reflective coating applied to a further surface of the surfaces.

22. A system, comprising:
imaging means for providing an image of a target based on light from the target;
optical means having a light-filtering coating blocking ambient light, the optical means focusing at least a portion of the light from the target onto the imaging means; and
processing means for decoding the image of the target.
